(19) United States
(12) Patent Application Publication
(10) Pub. No.: US 2014/0172641 A1
(43) Pub. Date: Jun. 19, 2014

(54) SYSTEMS AND METHODS FOR IDENTIFICATION AND/OR ACQUISITION OF A PRODUCT(s) OR ITEM(s)

(71) Applicant: DINESH SHARMA, Noida (IN)

(72) Inventor: DINESH SHARMA, Noida (IN)

(21) Appl. No.: 13/765,700

(22) Filed: Feb. 13, 2013

(30) Foreign Application Priority Data
Feb. 14, 2012 (IN) 416/DEL/2012

(51) Int. Cl. G06Q 30/06

(52) U.S. Cl. CPC G06Q 30/0623
USPC 705/26.61

(57) ABSTRACT

The present invention provides systems and methods for identification and/or acquisition of at least one product(s) or item(s), said system comprises:
tagging mechanism adapted to tag each product(s) or item(s) to be displayed with associated data or metadata to obtain tagged data;
device comprising at least a detector-sensor component, at least a display mechanism, at least an input mechanism, and at least a payment mechanism;
processing mechanism adapted to process said input order data and further adapted to interpret said received signals;
rule creation means adapted to allow a user to create rules; and
dispatch means in order to collate tagged data relating to various product(s) or item(s) that have been ordered and paid for using said payment mechanism and further adapted to arrange shipment of said product(s) or item(s).

### FIELD OF THE INVENTION

This invention relates to the field of electronic devices, information systems, and communication systems.

Particularly, this invention relates to a shopping system.

Specifically, this invention relates to systems and methods for identification and/or acquisition of a product(s) or item(s).

### BACKGROUND OF THE INVENTION

In the present scenario of retail and wholesale acquisition or purchase business, large number of products or goods need to be moved from manufacturers to suppliers (middle-men), then to retail vendors and/or retailers and further to consumers or customers at various storage locations, inventories, warehouses to retail stores and point of sales. Similarly, a buyer requires to physically come to a store to buy and carry the goods back with him and this may involve cost or expenditure for him as well along with physical labour. Also, a buyer may need to plan the visit to a retail store as he needs to carry goods bought with him which may or may not always be easily transportable. Cost of retail space is much higher than warehouse space, inventory space and cost of transaction and transport between such warehouse/storage space to retail showroom only adds to the expenses of the buyers and/or sellers.

Furthermore, inventory management is a task in itself. A first level of inventory management involves procedures relating to stocking inventory at warehouses from where it is distributed in wholesale to retailers. A second level of inventory management involves procedures relating to stocking inventory on shelves in a retail store and to see to it in a continuous fashion that the stocks are not relinquished altogether.

This involved considerable labour management and labour costs. Each of the inventory management levels and labour management levels are a cumbersome procedure requiring tailor-made detailing and planning and costs' factoring in to the product price.

There is a need to reduce such cumbersome, tiresome, managerial, labour-intensive, physically exhaustive, relatively expensive procedures.

Hence, there is a requirement of a system which shall not only reduce the need for retail space, transport costs but also help a buyer by delivering products or goods bought or acquired by him directly to his place of interest or desire.

US2010082485 relates specifically to a sales transaction through a device. US2010082485 discloses Systems, methods, and devices for conducting sales transactions. The patent application document discloses embodiments which include handheld, portable, electronic, point of purchase devices configured to acquire identification information from articles to be purchased, to determine a purchase price, and to acquire payment information for the purchase price.

US2010082485 does not explicitly describe formation of rules to provide a customised or pre-defined shopping experience. Nor does it describe the shopping experience in complete, wherein, the experience would end in the purchased products and/or items in reaching a desired destination in an efficient automated manner. US2010082485, hence, does not disclose user-rules-specific means for aiding the system and method of shopping. Also, US2010082485 does not disclose dispatching means for aiding a user of the shopping system and method to avail of shipment options in accordance with user-rules-specific means.

Hence, there is a need for a system and method which aims to provide a comprehensive shopping experience from recognizing a user to loading parameters or rules in relation to the user to completing a sales transaction to dispatching products in accordance with user-defined parameters.

### OBJECTS OF THE INVENTION

The object of the invention is to provide systems and methods for identification and/or acquisition of a product.

Another object of the invention is to provide a system and method which reduces costs.

Yet another object of the invention is to provide a system and method which reduces inventory management.

Still another object of the invention is to provide a system and method which reduces physical and managerial labour

Still another object of the invention is to provide a system and method which reduces retail space needs and thereby reducing power and utility needs at retail space.

An additional object of the invention is to provide a system and method which eliminates cumbersome procedures of stacking products or items.

### SUMMARY OF THE INVENTION

The present invention in a preferred embodiment provides systems and methods for identification and/or acquisition of a product(s) or item(s), wherein the system is an electronic system comprising,

a) a display screen;

b) a detector-sensor component; and

c) a pdq (process data quickly) component;

wherein detector-sensor component receives signals from a product or creates an associated data of a product, after which a processing unit of the electronic system connected to the detector-sensor component interprets the signal received or identifies the associated data of the product using a processing means/processing mechanism and displays data linked to the product on the display screen, wherein the display screen is also connected to the electronic system. A user may select or deselect a product(s) or item(s) displayed on the display screen at any time in the present or in future (till payment is made and transaction confirmed). The user may then proceed to make payment to acquire the selected product(s) or item(s) through the pdq component connected to the electronic system.

According to this invention, there is provided a system for identification and/or acquisition of at least one product(s) or item(s), said system comprises:

tagging mechanism adapted to tag each product(s) or item(s) to be displayed with associated data or metadata to obtain tagged data;

device comprising at least a detector-sensor component, at least a display mechanism, at least an input mechanism, and at least a payment, said detector-sensor component being adapted to receive signal(s) from said product in relation to tagged associated data of said product(s) or item(s) once said device is held in reading/detecting/sensing proximity to said product, said display mechanism being adapted to display said tagged data, said input mechanism being adapted to allow a user to input order data of said product(s) or item(s) that is detected/sensed and whose data is being displayed, said payment mechanism adapted to allow a user to pay a computed sum in relation to input order data in a real-time manner;

processing means/processing mechanism adapted to process said input order data and further adapted to interpret said received signals in order to identify tagged data of said product(s) or item(s);

rule creation means adapted to allow a user to create rules in relation to usage of said system; and

dispatch means in order to collate tagged data relating to various product(s) or item(s) that have been ordered and paid for using said payment mechanism and further adapted to arrange shipment of said product(s) or item(s) to corresponding said user according to pre-determined rules of shipment.

Preferably, said tagging mechanism comprises means to tag each product(s) or item(s) with associated data or metadata to obtain tagged data, said data being data items selected from a group consisting of but not limited to name, date of manufacture, expiry date (if any), cost, and the like data items.

Typically, said system includes a physical space adapted to display samples of said product(s) or item(s) with tagged data.

Alternatively, said system may be used in conjugation with an existing system, at a physical space meant for sale of said products

Alternatively, said system includes a physical space adapted to display dummy product(s) or item(s) with tagged data.

Alternatively, said system includes a physical space adapted to incorporate a display or a smart display (such as a computerised display) of product(s) or item(s) with tagged data.

Typically, said input mechanism is selection/rejection input mechanism.

Additionally, said input mechanism is an alphanumerical input means.

Additionally, said input mechanism is a biometric identification input means.

Typically, said input mechanism includes entry means adapted to allow a user to input a unique user code and/or password in order to allow said device to fetch user details, if pre-registered.

Preferably, said input mechanism includes entry means adapted to allow a user to input a unique user code and/or password in order to allow said device to fetch and apply rules from said rule creation engine, if pre-registered, said rules being user-specific rules.

Typically, said payment mechanism is a pdq (process data quickly) component, said component comprising card terminals that can perform or authorise transactions with a debit card or a credit card, Magnetic and Smart Card Readers, magnetic stripe card readers, data input devices, or any combination thereof.

Typically, said processing means comprises a client component on said device adapted to be communicably coupled with a local or remotely located server component.

Typically, said processing means comprises a local or remotely located server component adapted to be communicably coupled with a client component on said device.

Typically, said processing means comprises a client component on said device adapted to be communicably coupled with a local or remotely located server component, said server component further comprising databases of product(s) or item(s), tagged data, and other pre-defined rules.

Preferably, said processing means comprises a client component on said device adapted to be communicably coupled with a local or remotely located server component, said server component further comprising databases of product(s) or item(s), tagged data, time for shipment in relation to customer details, discount or offer details, communication from the manufacturer in relation to various parameters or shipment or other notifications, and the like store-related or product-related to manufacturer-related details.

Typically, said processing means comprises additional processing means to process various pre-determined parameters and further comprising estimation means adapted to provide an estimate of shipment of said ordered and paid product(s) or item(s).

Typically, said processing means comprises computation means adapted to compute sum of all selected product(s) or item(s).

Preferably, said rule creation engine includes rules relating to pre-defined list of product(s) or item(s) which may be invoked (or populated to be ordered) once the user enters his/her code and/or password on any device.

Preferably, said rule creation engine includes rules relating to shipment preference options in relation to mode of shipment, time allowances, date allowances, and the like to create a personalised shopping cum shipment experience.

According to this invention, there is also provided a method for identification and/or acquisition of a product(s) or item(s), wherein the method comprises the steps of:

tagging each product(s) or item(s) by a tagging mechanism, to be displayed with associated data or metadata to obtain tagged data;

using a device with detector-sensor component for receiving signals from said product(s) or item(s) in relation to tagged associated data of said product(s) or items once, said detector-sensor component is held in reading/detecting/sensing proximity to said product(s) or items;

displaying of said product(s) or item(s) that is detected/sensed by a display mechanism of the said device;

allowing a user to input order data by input mechanism of the said device, for product(s) or item(s) whose data is being displayed;

allowing a user to pay a computed sum by payment mechanism of the said device, in relation to input order data in a real-time manner;

processing by processing means/processing mechanism of said input order data and further adapted to interpret said received signals in order to identify tagged data of said product(s) or item(s);

allowing a user to create rules in relation to usage of said system by a rule creation means; and

collating tagged data relating to various product(s) or item(s) by a dispatch means that have been ordered and paid for using said payment mechanism and further arranging shipment of said product(s) or item(s) to corresponding said user according to pre-determined rules of shipment.

Preferably, said step of tagging comprising a step of tagging each product(s) or item(s) with associated data or metadata to obtain tagged data, said data being data items selected from a group consisting of but not limited to name, date of manufacture, expiry date (if any), cost, and the like data items.

Typically, said method comprising a step of displaying samples of said product(s) or item(s) with tagged data in a physical space.

Alternatively, said method comprising a step of displaying samples of said dummy product(s) or item(s) with tagged data in a physical space.

Alternatively, said method comprising a step of displaying display or a smart display (such as a computerised display) of product(s) or item(s) with tagged data in a physical space.

Typically, said step of allowing a user to input order data comprises a step of selecting/rejecting order of each detected/sensed/read product or items by said device.

Additionally, said step of allowing a user to input order data comprises a step of allowing a user to input a unique user code and/or password in order to allow said device to fetch user details, if pre-registered.

Additionally, said step of allowing a user to input order data comprises a step of allowing a user to input a unique user code and/or password in order to allow said device to fetch and apply rules from said rule creation engine, if pre-registered, said rules being user-specific rules.

Typically, said step of allowing a user to a computed sum comprises a step of payment using a pdq (process data quickly) component, said component comprising card terminals that can perform or authorise transactions with a debit card or a credit card, Magnetic and Smart Card Readers, magnetic stripe card readers, data input devices, or any combination thereof.

Typically, said method comprises a step of collating tagged data relating to various product(s) or item(s) that have been ordered and paid for using said device.

Typically, said method comprises a step of collating tagged data relating to various product(s) or item(s) that have been ordered and paid for using said device and further comprising a step of dispatching in order to arrange shipment of said collated product(s) or item(s) to corresponding said user according to pre-determined rules of shipment.

Typically, said step of processing said input order data comprises a step of communicably coupling a client component on said device with a local or remotely located server component.

Typically, said step of processing said input order data comprises a step of communicably coupling a local or remotely located server component with a client component on said device.

Typically, said step of processing said input order data comprises a step of communicably coupling a client component on said device with a local or remotely located server component and further communicably coupling databases of product(s) or item(s), tagged data, and other pre-defined rules.

Preferably, said step of processing said input order data comprises a step of communicably coupling a client component on said device with a local or remotely located server component and further communicably coupling databases of product(s) or item(s), tagged data, time for shipment in relation to customer details, discount or offer details, communication from the manufacturer in relation to various parameters or shipment or other notifications, and the like store-related or product-related to manufacturer-related details.

Typically, said step of processing said input order data comprises a step of processing various pre-determined parameters and further estimating shipment of said ordered and paid product(s) or item(s).

Typically, said step of processing said input order data comprises a step of computing sum of all selected product(s) or item(s).

Preferably, said step of allowing a user to create rules comprises a step of creating rules relating to pre-defined list of product(s) or item(s) which may be invoked (or populated to be ordered) once the user enters his/her code and/or password on any device.

Preferably, said step of allowing a user to create rules comprises a step of creating rules relating to shipment preference options in relation to mode of shipment, time allowances, date allowances, and the like to create a personalised shopping cum shipment experience.

### BRIEF DESCRIPTION OF THE ACCOMPANYING DRAWINGS

The invention will now be described in relation to the accompanying drawings, in which:

FIG. 1 illustrates a schematic block diagram of the system; and

FIG. 2 illustrates a schematic flowchart of the method.

### DETAIL DESCRIPTION OF THE ACCOMPANYING DRAWINGS

The present invention in a preferred embodiment provides systems for identification or acquisition of a product(s) or item(s), wherein the system is an electronic system comprising,

a) a display screen;

b) a detector-sensor component; and

c) a pdq (process data quickly) component;

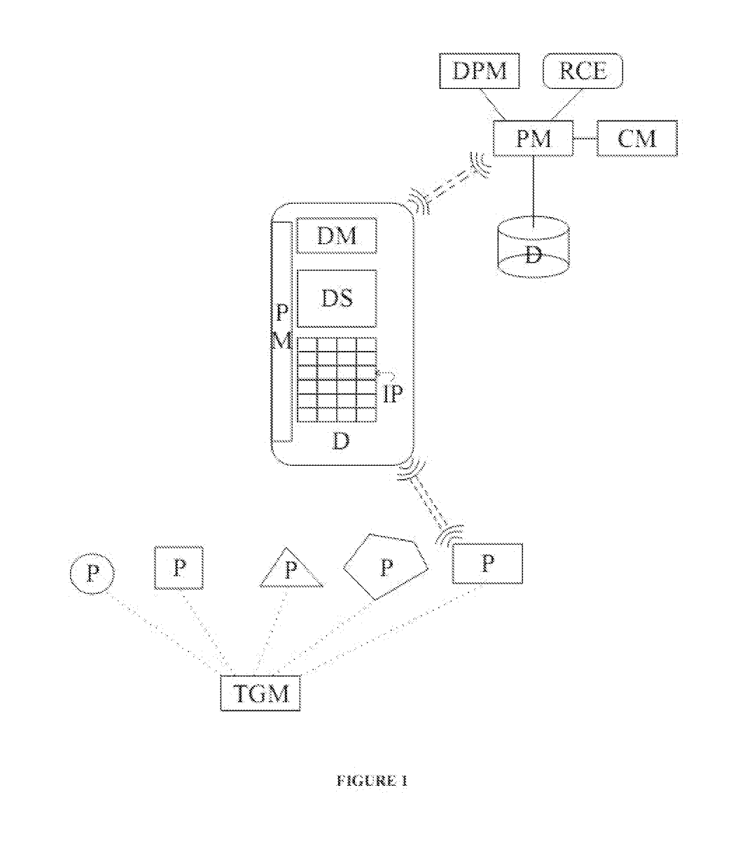

FIG. 1 illustrates a schematic block diagram of the system of this invention.

In accordance with an embodiment of this invention, there is provided a tagging mechanism (TGM) adapted to tag each product or item (P) to be displayed in a physical space with associated data or metadata. Each product may include associated data such as name, date of manufacture, expiry date (if any), cost, and the like. A sample of the product may be displayed in a retail space. Alternatively, a dummy product or item may be displayed in a retail space. Still alternatively, a display or a smart display (such as a computerised display) may be displayed in a retail space. This instantaneously reduces the cost and labour involved in stacking up a plurality of such product(s) or item(s). The tagging mechanism is invoked prior to display.

In accordance with another embodiment of this invention, there is provided a device (D) with a detector-sensor component (DS). The detector-sensor component is adapted to receive signals from a product(s) or item(s) in relation to tagged associated data of the product(s) or item(s). The device typically comprises a display mechanism (DM) adapted to display all the tagged or associated data once the device is held in reading/detecting/sensing proximity to a product(s) or item(s).

In accordance with yet another embodiment of this invention, there is provided an input mechanism (IP) at the device adapted to allow a user using the device to input order data of the item(s) or product(s) that is detected/sensed and whose data is being displayed. This may be selection/rejection entry. Typically, an alphanumerical input means is provided. Additionally, a biometric identification input means may also be provided. Preferably, a quantity input is made along with selection of product(s) or item(s). A user may select or deselect a product displayed on the display screen at any time in the present or in future (till transaction closing or payment made) using the input means and the display means. The input mechanism may also be used to input unique client code and/or password in order to allow the device to fetch client details if pre-registered for a better user experience.

In accordance with still another embodiment of this invention, there is provided a processing means/processing mechanism (PM) adapted to process the input data of the user and further adapted to interpret the signal received or to identify the associated data of the product(s) or item(s) using a processing mechanism. The processing mechanism may include a client component on the device and may be communicably coupled with a server component residing elsewhere (even locally for a standalone store?). The server component typically includes databases (D) of product items, associated data, time for shipment in relation to customer details, discount or offer details, communication from the manufacturer in relation to various parameters or shipment or other notifications, and the like store-related or product-related to manufacturer-related details. The processing mechanism, hence, is adapted to process these various pre-determined parameters to provide an estimate of shipment. The processing mechanism also includes computation means (CM) to compute sum of all selected product(s) or item(s).

In accordance with an additional embodiment of this invention, there is provided a device based payment mechanism (DBPM) adapted to allow a user to pay the computed sum in an a real-time manner. This is typically a pdq (process data quickly) component, which for the purpose of this invention, shall include card terminals that can perform or authorise transactions with a debit card or a credit card, Magnetic and Smart Card Readers, magnetic stripe card readers, data input devices, or any combination thereof. Once the transaction is secured and determined, the processing means invokes a dispatch means (DPM) on the server component in order to collate data relating to the various product(s)/item(s) that have been ordered and paid for and arranges to ship them to the user according to pre-determined rules of shipment.

In accordance with yet an additional embodiment of this invention, there is provided a rule creation means (RCE) adapted to allow a user to create rules in relation to the shopping experience that person desires. These rules may include a pre-defined list of product(s or items which may be invoked (or populated to be ordered) once the user enters the customer code and/or password on any device. These rules may further include shipment preference options in relation to mode of shipment, time allowances, date allowances, and the like to create a personalised shopping cum shipment experience.

According to this invention, there is provided a method for identification and/or acquisition of a product(s) or item(s), wherein the method comprises the following steps:

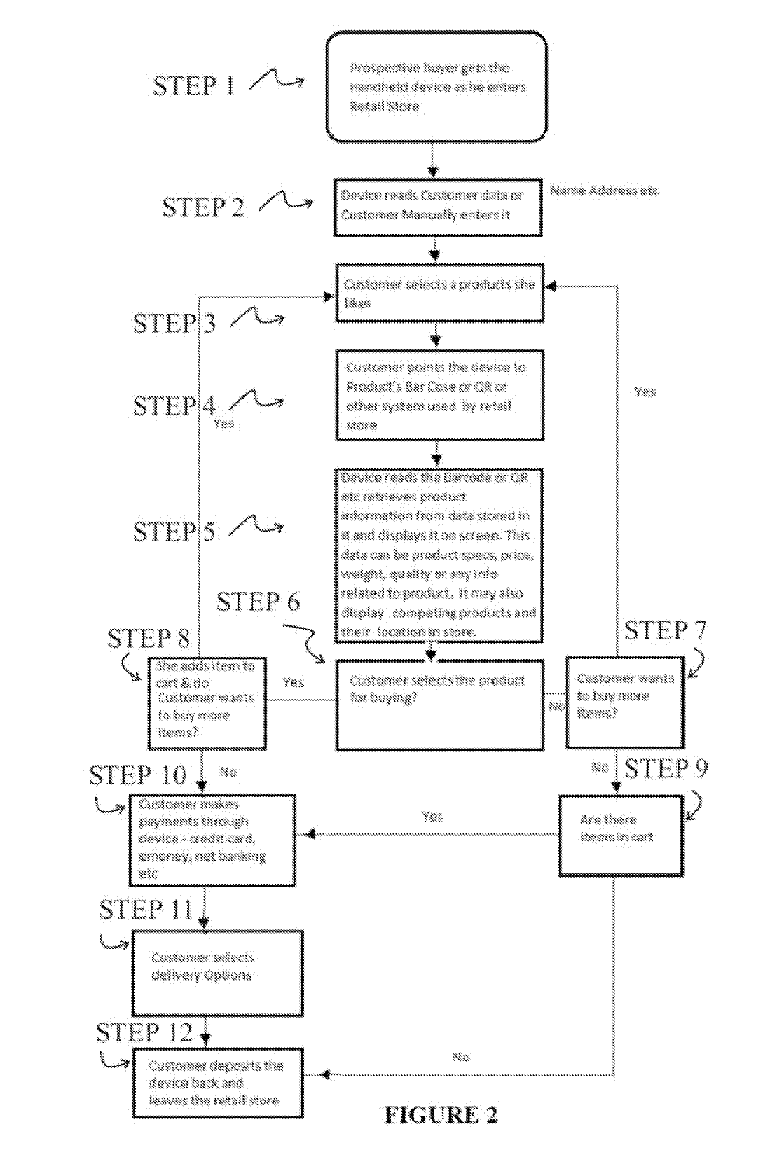

FIG. 2 illustrates a schematic flowchart of the method of this invention.

Step 1: A prospective buyer/user/customer gets the device, of this invention, as person enters a store (or any business establishment that sells goods).

Step 2: The input mechanism may be invoked to allow a user to enter user/customer data. (same can also be read from card etc. issued to customer by swiping it on device)

Step 3: The user/customer selects a product or item that he/she has an intention to purchase.

Step 4: The user/customer points the device, of this invention, towards the product or item that he/she has intentioned to purchase OR brings it within device-reading distance or device-sensing distance of the product(s) or item(s) that he/she has intentioned to purchase.

Step 5: The device, of this invention, reads the tagged information of the product(s) or item(s) and display it on the display means of the device.

Step 6: The user/customer selects the product(s) or item(s) that he/she has intentioned to buy and whose data has been read by the device of this invention. This selection may be performed by the input mechanism of the device of this invention.

Step 7: The user/customer may select more than one item or product, for which Steps 3 to 6 are repeated.

Step 8: Once the user has input all item(s) or product(s), the computation means of the processing means of the system of this invention is invoked to compute a sum of all the selected product(s) or item(s). Here, all offers, discounts, or any other user-specific or customer-specific rules of computation may be invoked.

Step 9: The user/customer/system checks if there are any additional product(s)/item(s) in cart.

Step 10: Payment for the computed sum is facilitated through a device based payment mechanism.

Step 11: Once payment transaction is secured and authorised, user/customer may select delivery options or the delivery options may be pre-defined and stored along with customer identity.

Step 12: User/customer exits account from the device, deposits the device back in the store or may take the device back for later use from home or physical location use, leaves the store, and delivery is made by invoking a dispatch mechanism.

Note—At any stage, user has the option to deselect a previously selected item from the list.

In an embodiment of the invention, the various systems and methods of the present invention shall allow a user to make payments and disbursements through various modes of exchanging or provisioning such as but not limited to electronic transfer of money or currency, debit cards, credit cards, cash, cheque, bank transfer, recurring cash or ACH (Automated Clearing House), magnetic stripe card, smartcard, contactless card, mobile payments, or any combination thereof.

In an embodiment of the invention, the detector-sensor component may identify a product or item from various identifiers such as but not limited to bar code, stock-keeping unit (SKU), Radio Frequency Identification, electronic product code (EPC), Universal Product Code (UPC), Global Trade Item Number (GTIN), Serialised Global Trade Item Number (SGTIN), Global Returnable Asset Identifier (GRAI), National Drug Code (NDC), Uniform Grocery Product Code, images created, pictures captured, or any combination thereof.

In an embodiment of the invention, the detector-sensor component may be various devices or input components such as but not limited to a keyboard, a mouse, a joystick, a touchpad, a virtual keyboard, a virtual data entry user interface, a virtual dial pad, a software or a program, a scanner such as RFID readers or code scanners, a remote device, a microphone, a webcam, a camera, a fingerprint scanner, a High-degree of freedom input devices such as that used in a cave, pointing stick, or any combination thereof.

In an embodiment of the invention, the various systems and methods of the present invention shall be used to provide or access information linked to a user or a product or item such as but not limited to cost of the product, dimensions of the product, weight of the product, manufacturing date of the product, expiry date of the product, user name, user details, user banking details, user preferences, or any combinations thereof.

In an embodiment of the invention, the acquired products may be delivered to user's location of interest, wherein the user may not be required to carry or transport the acquired products.

In an embodiment of the invention, the user may select a mode of delivery or a time of delivery of the products acquired through various systems and methods of the invention.

In an embodiment of the invention, the electronic system may be further connected to a generator of bill or purchase voucher or invoice or proof of purchase, wherein the bill or purchase voucher or invoice or proof of purchase may be printed or transferred electronically to an acquirer.

In an embodiment of the invention, the processing unit of the electronic system connected to the detector-sensor component interprets the signal received or identifies the associated data of the product using a processing means/processing mechanism, wherein the processing mechanism shall involve computing, processing, comparing or analyzing data or metadata stored in one or more data storage units using one or more of a pre-defined algorithms or protocols for sorting or processing associated data of the product or item. The pre-defined algorithms or protocols or logic interprets and executes instructions for processing associated data of the product and may be implemented by using any know or new micro-processors, mini- or mainframe computers or even plurality of such processors operating in parallel or as a pipeline. Algorithms or protocols or logic may be used for functions comprising of one or more of:

a) sorting or matching or mapping associated data of the product or item;

b) locating or identifying associated data of the product or item within the stored data or information in the data storage unit or with information available on one or more networking systems;

c) isolating or extracting matching data or information or request;

d) categorising or indexing or ranking of associated data of the product.

In an embodiment of the invention, the data storage unit or data storage device is selected from a set of, but not limited to, USB flash drive (pen drive), phone memory, computer memory, memory card, optical data storage discs, hard disk drive, magnetic disk, magnetic tape data storage device, data server and molecular memory.

In an embodiment of the invention, the functions performed by the processing mechanism such as sorting or matching; locating or identifying; isolating or extracting; categorising or indexing or ranking may be optionally performed independent of one another.

A user is any person, machine or software that uses or accesses one or more of the systems or methods of the present invention. A user includes an automated computer program and a robot. A user for the purpose for this invention shall include consumer or purchaser or shopper or buyer or procurer or customer or client or payer or assistant buyer of a product.

In an embodiment of the invention, the systems and methods can be practised using any electronic system. An electronic system for the purpose of this invention is selected from any system capable of processing or representing data to a user and providing access to a network or any system similar to the internet, wherein the electronic system may be selected from but not limited to, personal computers, mobile phones, laptops, palmtops, portable media players, iphones, smart phones, ipads, electronic reader, and personal digital assistants.

In an embodiment of the invention, the systems and methods of the present invention are used to prevent or restrict hacking or related phenomenon such as but not limited to phishing, man in the middle attack, inside jobs, rogue access points, back door access, use of viruses and worms, use of trojan horses, denial of service attack, sniffing, spoofing, ransomware or any combination thereof.

In an embodiment of the invention, the systems and methods can be practised using any electronic system which may be connected to one or more of other electronic system with wires or wirelessly which may use technologies such as but not limited to, Bluetooth, WiFi, Wimax. This will also extend to use of the aforesaid technologies to provide an authentication key or access key or electronic system based unique key or any combination thereof.

In an embodiment of the invention, the systems and methods can be practised using any electronic system which may contain or may be infected by one or more of an undesirable software such as but not limited to a virus, or a Trojan, or a worm, malware, spyware, adware, scareware, crimeware, rootkit or any combination thereof.

In an embodiment of the invention the system may involve software updates or software extensions or additional software applications.

In an embodiment of the invention, any form of internet security such as but not limited to, a firewall or antivirus or antimalware or registry protection can be used by a user in the same or different electronic system either simultaneously or separately, along with the systems or methods of the present invention.

The described embodiments may be implemented as a system, method, apparatus or article of manufacture using standard programming or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

The process steps, method steps, protocols, algorithms or the like may be described in a sequential order, such processes, methods, protocol and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

Furthermore, this invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures. It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

The aim of this specification is to describe the invention without limiting the invention to any one embodiment or specific collection of features. Person skilled in the relevant art may realize the variations from the specific embodiments that will nonetheless fall within the scope of the invention.

It may be appreciated that various other modifications and changes may be made to the embodiment described without departing from the spirit and scope of the invention.

I claim:

1. A system for identification and/or acquisition of at least one product(s) or item(s), said system comprising:
tagging mechanism adapted to tag each product(s) or item(s) to be displayed with associated data or metadata to obtain tagged data;
device comprising at least a detector-sensor component, at least a display mechanism, at least an input mechanism, and at least a payment mechanism, said detector-sensor component being adapted to receive signal(s) from said product in relation to tagged associated data of said product(s) or item(s) once said device is held in reading/detecting/sensing proximity to said product, said display mechanism being adapted to display said tagged data, said input mechanism being adapted to allow a user to input order data of said product(s) or item(s) that is detected/sensed and whose data is being displayed, said payment mechanism adapted to allow a user to pay a computed sum in relation to input order data in a real-time manner;
processing means/processing mechanism adapted to process said input order data and further adapted to interpret said received signals in order to identify tagged data of said product(s) or item(s);
rule creation means adapted to allow a user to create rules in relation to usage of said system; and
dispatch means in order to collate tagged data relating to various product(s) or item(s) that have been ordered and paid for using said payment mechanism and further adapted to arrange shipment of said product(s) or item(s) to corresponding said user according to pre-determined rules of shipment.

2. A system as claimed in claim 1 wherein, said tagging mechanism comprising means to tag each product(s) or item(s) with associated data or metadata to obtain tagged data, said data being data items selected from a group consisting of name, date of manufacture, expiry date (if any), cost, and the like data items.

3. A system as claimed in claim 1 wherein, said system includes a physical space adapted to display samples of said product(s) or item(s) with tagged data.

4. A system as claimed in claim 1 wherein, said system may be used in conjugation with an existing system, at a physical space meant for sale of said products.

5. A system as claimed in claim 1 wherein, said system includes a physical space adapted to display dummy product(s) or item(s) with tagged data.

6. A system as claimed in claim 1 wherein, said system includes a physical space adapted to incorporate a display or a smart display (such as a computerised display) of product(s) or item(s) with tagged data.

7. A system as claimed in claim 1 wherein, said input mechanism is selection/rejection input mechanism.

8. A system as claimed in claim 1 wherein, said input mechanism is selected from a group consisting of an alphanumerical input means, a biometric identification input means, and a combination thereof.

9. A system as claimed in claim 1 wherein, said input mechanism includes entry means adapted to allow a user to input a unique user code and/or password in order to allow said device to fetch user details, if pre-registered.

10. A system as claimed in claim 1 wherein, said input mechanism includes entry means adapted to allow a user to input a unique user code and/or password in order to allow said device to fetch and apply rules from said rule creation engine, if pre-registered, said rules being user-specific rules.

11. A system as claimed in claim 1 wherein, said payment mechanism is a pdq (process data quickly) component, said component comprising card terminals that can perform or authorise transactions with a debit card or a credit card, Magnetic and Smart Card Readers, magnetic stripe card readers, data input devices, or any combination thereof.

12. A system as claimed in claim 1 wherein, said processing means comprising a client component on said device adapted to be communicably coupled with a local or remotely located server component.

13. A system as claimed in claim 1 wherein, said processing means comprising a local or remotely located server component adapted to be communicably coupled with a client component on said device.

14. A system as claimed in claim 1 wherein, said processing means comprising a client component on said device adapted to be communicably coupled with a local or remotely located server component, said server component further comprising databases of product(s) or item(s), tagged data, and other pre-defined rules.

15. A system as claimed in claim 1 wherein, said processing means comprising a client component on said device adapted to be communicably coupled with a local or remotely located server component, said server component further comprising databases of product(s) or item(s), tagged data, time for shipment in relation to customer details, discount or offer details, communication from the manufacturer in relation to various parameters or shipment or other notifications, and the like store-related or product-related to manufacturer-related details.

16. A system as claimed in claim 1 wherein, said processing means comprising additional processing means to process various pre-determined parameters and further comprising estimation means adapted to provide an estimate of shipment of said ordered and paid product(s) or item(s).

17. A system as claimed in claim 1 wherein, said processing means comprising computation means adapted to compute sum of all selected product(s) or item(s).

18. A system as claimed in claim 1 wherein, said rule creation engine includes rules relating to pre-defined list of product(s) or item(s) which may be invoked (or populated to be ordered) once the user enters his/her code and/or password on any device.

19. A system as claimed in claim 1 wherein, said rule creation engine includes rules relating to shipment preference options in relation to mode of shipment, time allowances, date allowances, and the like to create a personalised shopping cum shipment experience.

20. A method for identification and/or acquisition of a product(s) or item(s), wherein the method comprising the steps of:
tagging each product(s) or item(s) by a tagging mechanism, to be displayed with associated data or metadata to obtain tagged data;
using a device with detector-sensor component for receiving signals from said product(s) or item(s) in relation to tagged associated data of said product(s) or items once, said detector-sensor component is held in reading/detecting/sensing proximity to said product(s) or items;
displaying of said product(s) or item(s) that is detected/sensed by a display mechanism of the said device;
allowing a user to input order data by input mechanism of the said device, for product(s) or item(s) whose data is being displayed;
allowing a user to pay a computed sum by payment mechanism of the said device, in relation to input order data in a real-time manner;
processing by processing means/processing mechanism of said input order data and further adapted to interpret said received signals in order to identify tagged data of said product(s) or item(s);
allowing a user to create rules in relation to usage of said system by a rule creation means; and
collating tagged data relating to various product(s) or item(s) by a dispatch means that have been ordered and paid for using said payment mechanism and further arranging shipment of said product(s) or item(s) to corresponding said user according to pre-determined rules of shipment.
